(19) United States
(12) Patent Application Publication
(10) Pub. No.: US 2009/0240533 A1
(43) Pub. Date: Sep. 24, 2009

(54) SYSTEM AND METHOD FOR ALIGNING CREDIT SCORES

(76) Inventor: Lawrence Koa, Dublin, CA (US)

Correspondence Address: IAN F. BURNS & ASSOCIATES, 4790 Caughlin Parkway #701, RENO, NV, 89519-0907, US

(21) Appl. No.: 12/407,399

(22) Filed: Mar. 19, 2009

Related U.S. Application Data
(60) Provisional application No. 61/038,177, filed on Mar. 20, 2008.
(60) Provisional application No. 61/038,199, filed on Mar. 20, 2008.

(51) Int. Cl. G06Q 40/00

(52) U.S. Cl. 705/4

(57) ABSTRACT

In competitive pricing analysis, a dataset of insurance premium quotes having associated insurance rating parameters such as credit scores or tiers can be ranked by the average insurance premium for each unique value of the insurance rating parameter. The rankings establish price points that can be aligned with price point rankings of multiple other insurance companies that use different methods or algorithms for determining the insurance rating parameter. The alignment of rankings for different insurance companies allow different parameter systems to be correlated.

### CROSS REFERENCE TO RELATED APPLICATIONS

This application claims priority to U.S. provisional patent application Ser. No. 61/038,199, filed Mar. 20, 2008, the contents of which is herein incorporated by reference.

### FIELD OF THE INVENTION

The present invention relates to competitive pricing analysis and in particular to competitive pricing analysis of insurance premiums that are based on insurance rating parameters such as credit scores or tiers.

### BACKGROUND

Many insurance carriers assess financial risk using an already established relationship between an individual's credit history and loss potential. Some factors that may affect an individual's credit history include the individual's payment history, length of credit, amounts owed, new credit and types of credit used. Credit bureaus will summarize an individual's credit history through a credit score and this score in turn is used by the insurance carriers as one of the variables in determining an individual's rate. Most credit scores, commonly called the FICO score, used in the US are produced by Fair Isaac and Company (FICO) and these scores are reported to major credit reporting agencies like Equifax, Experian and TransUnion. This score currently provides the best guide to accessing the insured's credit risk. The higher the score, the lower the risk. However, credit bureaus like FICO do not provide breakdowns of which scores fall into an excellent, good or bad risk. It is left to the insurance carrier to make that determination. Also, not all insurance carriers utilize Fair Isaacs FICO score. There are also other credit bureau companies that carriers may opt to use or the insurance carriers may have adopted their own unique credit score development algorithm or strategy. This results in carriers having their own unique set of credit scores.

The value for credit risk is different for each carrier and how individual insurance carriers' have developed their particular credit risk values is unknown. Insurance carriers are not required to file their credit score determination algorithms and tend to treat these algorithms as proprietary. A problem with their being a non-standard set of credit scores is that it poses a challenge for competitive pricing analysis, in particular, aligning one carrier's unique score to another carrier's score when comparing insurance rates and for customers achieving the best rate for their set of circumstances.

In alternative forms, tier underwriting guidelines may be available for multiple carriers. It is possible to program carrier rates to calculate the tier a carrier would rate with (i.e., auto-tier) per inputs of combinations of variables in each quote (e.g., Driver Ages, Accidents/Violations, Credit Score, Prior Liability Limits, Vehicle Age, Performance, Coverage Limits, etc). However, with carriers filing their tier underwriting guidelines as proprietary information it can be difficult to acquire the necessary data. Without these underwriting guidelines the tier that the carrier would rate the policy with per combination of variables and their inputs in each quote cannot be determined. In addition, the trend over the past couple of years has been to include more and more tier levels, with some carriers having more than one hundred distinct tier levels. Lack of underwriting data and expanding tier levels pose a challenge in aligning the unique tier levels for each carrier.

What is required is a system and method that can assist in aligning insurance rating parameters such as credit scores and/or tiers for a plurality of insurance carriers.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to align a set of values of an insurance rating parameter of a first insurance carrier with a set of alternative values of the insurance rating parameter of a second insurance carrier; and

provide a mechanism for comparing values of an insurance rating parameter of a plurality of insurance carriers; and

provide a mechanism for competitive price analysis of companies that use different methodologies to determine financial risk.

These and other advantages may be realized by reference to the remaining portions of the specification, claims, and abstract.

### Brief Description of One Embodiment of the Present Invention

In one aspect, the invention relates to a method for aligning an insurance rating parameter for a plurality of insurance carriers. In the method a plurality of datasets of quotes may be created for a plurality of companies. The datasets may associate a plurality of insurance premiums with a plurality of values of the insurance rating parameter. The datasets may be ranked by ranking the insurance premium. Two or more datasets may be aligned by aligning the ranking of a first dataset with the ranking of a second dataset such that an aligned dataset correlates the insurance rating parameter of a first company and a second company.

In one aspect, the invention relates to a method for correlating a first company's credit score with at least one other company's credit score. In the method, an input credit score for the first company may be received and used as an index to a database that stores correlated credit scores for a plurality of companies. A correlated credit score of at least one other company may be retrieved from the database using the input credit score as an index.

In one aspect, the invention relates to a method for correlating a first company's tiers with at least one other company's tiers. In the method, an input tier for the first company may be received and used as an index to a database that stores correlated tiers for a plurality of companies. A correlated tier of at least one other company may be retrieved from the database using the input tier as an index.

In one aspect, the invention relates to a system comprising a database and a host. The database may store a plurality of datasets, each dataset associating a plurality of insurance premiums with a plurality of values of an insurance rating parameter. The host may be configured to execute a query on the database to align the insurance rating parameter of a first company with the insurance rating parameter of at least one further company.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of the credit score alignment system;

FIG. 2 is substantially a flowchart depicting a credit score alignment method;

FIG. 3 substantially depicts a first credit score dataset for a first company;

FIG. 4 substantially depicts a second credit score dataset for a second company;

FIG. 5 substantially depicts an alignment of the first and second credit score datasets;

FIG. 6 substantially depicts a first tier dataset for a first company;

FIG. 7 substantially depicts a second tier dataset for a second company;

FIG. 8 substantially depicts an alignment of the first and second tier datasets;

FIG. 9 substantially depicts a flowchart for looking up credit scores on a correlated credit score data table;

FIG. 10 substantially depicts an example of a book of business for a first company with equivalent insurance scores for the first company and unknown insurance scores for a second company;

FIG. 11 substantially depicts a set of insurance scores for the first company;

FIG. 12 substantially depicts a set of insurance scores for the second company;

FIG. 13 substantially depicts an alignment table for the first and second companies; and

FIG. 14 substantially depicts the book of business of FIG. 10 with known equivalent insurance scores for the second company.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

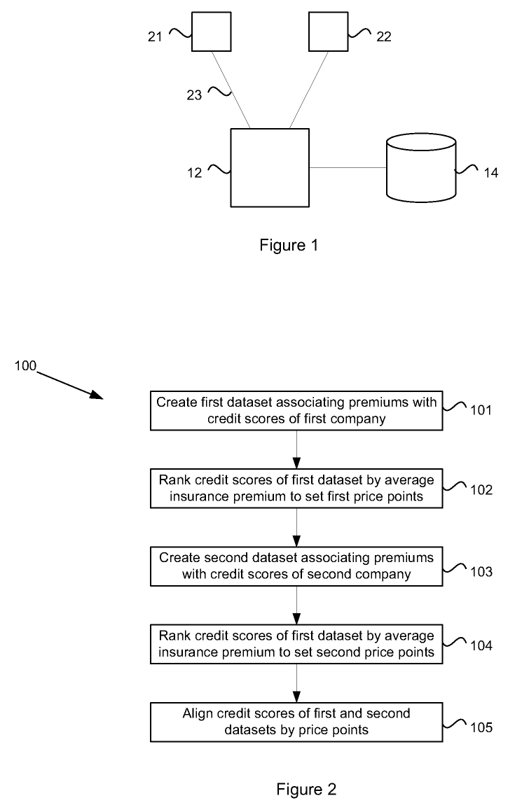

A system in accordance with an embodiment of the invention is illustrated in FIG. 1. In the system 10, a host 12, such as from a competitive pricing analyst, interfaces with a plurality of insurance carriers 21, 22 through suitable communications links 23, such as the internet, File Transfer Protocols (FTP), phone links, interactive voice response systems or any suitable communications links. The host 12 accesses the insurance carriers 21, 22 to obtain insurance premium quotes. Typically, the quotes will include an insurance premium and an associated insurance rating parameter which may be stored together by the host 12 in the database 14. Insurance rating parameters are used by many insurance companies as a summary of a combination of variables. For example, an insurance rating parameter for a vehicle insurance policy may incorporate such variables as driver ages, accidents/violations, prior liability limits, vehicle age, performance, coverage limits. In one embodiment, the insurance rating parameter may include a credit score. In one embodiment, the insurance rating parameter may include a tier. Credit scores and tiers are commonly used in the insurance industry and are considered to be terms of art, though a person skilled in the art will readily understand that equivalent terms may be used to describe these types of insurance rating parameters.

The host may process the quote data to provide competitive price analysis and recommendations and advice regarding the insurance carriers. A problem with providing the advice is that the different values of the insurance rating parameters used by different insurance carriers make it difficult to compare product offerings. In one embodiment, there is provided a process for credit alignment, depicted in the flowchart 100 of FIG. 2. In the process 100, a first dataset of quotes is created for a first company and stored in the database 14. The quote dataset associates an insurance premium with an insurance rating parameter such as a credit score or tier. Other input variables that determine the insurance premium, such as will be described in more detail below, can also be stored in association with the credit score and insurance premium in a dataset record. At step 102, the insurance rating parameters are ranked according to their associated insurance premiums to establish a first set of price points. Where the dataset contains multiple insurance premiums for a single value of the insurance rating parameter, the average premium for that value may first be calculated. The process of creating and ranking a dataset is then repeated at steps 103, 104 for a second company and any subsequent companies. At step 105, the ranked datasets for the different companies are aligned by price points to correlate the values of the insurance rating parameter for each of the insurance companies in the aligned dataset.

For a typical insurance carrier, the insurance premium indicates how the carrier determines the risk level for a particular risk. Simply put, the higher the premium, the higher the risk level (loss potential). How a carrier assigns levels of risk for a certain variable in a policy's rate can be determined by modifying the variable's value with all the possible values for this variable and generating premiums for each value. The premiums and its associated variable value can then be sorted and price points can be determined. These price points provide an indication of how a carrier factors in a particular variable in their rates as well as what level of risk or loss potential is associated with each value.

Equivalently priced premiums can be used to align premium pricing scores and methodologies of the various insurance carriers. In one embodiment, this is done by creating quotes for each unique carrier credit score (or tier) and determining the premiums associated with each score. Then price points can be determined allowing the scores to be grouped together to see which groups are considered good risks (the ones that generate lower premiums) and which groups are considered bad (the ones that generate higher premiums).

The price points are determined by taking a first dataset of quotes for a first company from the database 14 and rating these quotes for each credit score the company has. The host then generates a table of credit scores and the average premium for each score from the quote dataset. The scores are then sorted and ranked by the average premiums. The rankings determine the price points. The lowest rank is the price points for the best credit scores and the highest rank is for the worst. This process is then repeated by selecting a second dataset of quotes for a second company and for any subsequent company datasets.

Once the price points have been determined for each company, the price points can be aligned by mapping the price points from one dataset to the price points of another dataset(s). A similar procedure can be followed using tiers in place of the credit scores.

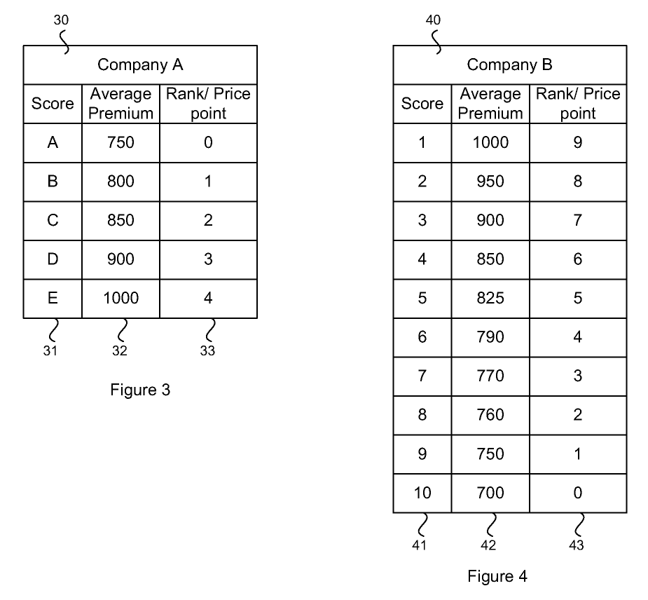

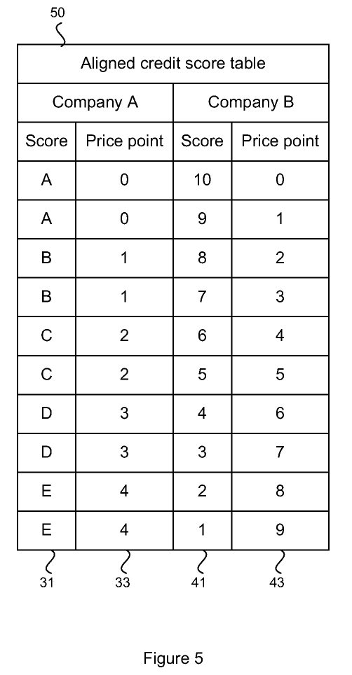

In an example, it is desired to align the credit scores of Company A with the credit scores of Company B. A first dataset for Company A may by processed to average the premiums against the credit scores, resulting in a table 30 shown in FIG. 3 that associates the credit scores of Company A in the first column 31 with the Average premium for a credit score in the second column 32. A third column 33 of the table 30 ranks the credit scores, thereby establishing the price points. A similar table 40 may be generated for a dataset pertaining to Company B, with similar columns for credit score 41, average premium 42 and rank/price point 43.

Table 30 and table 40 may be aligned to produce an aligned data table 50 shown in FIG. 5. In this example, the aligned data table may be produced by a 2:1 mapping from table 30 to table 40. The aligned table 50 shows the credit scores 31 and price points 33 of the Company A table 30 mapped and aligned with the credit scores 41 and price points 43 of the Company B table 40. In this alignment, the credit scores of Company A are correlated with the credit scores of Company B.

The alignment of datasets using the price points produces the credit score alignment. For example, rank 0 of Company A aligns with rank 0 and rank 1 of Company B.

The aligned data table 50 may be provided as the results of a database query which may then be displayed on the host interface 12, printed or transmitted to an end user such as an insurance customer. In addition, the aligned table may be electronically stored, such as in the database 14, to save re-executing the query or to incorporate the aligned table data into reports and the like. In an alternative embodiment, the aligned table data 50 may be generated upon each request, i.e. by executing the credit alignment query, thereby ensuring that the most up to date quote data is used.

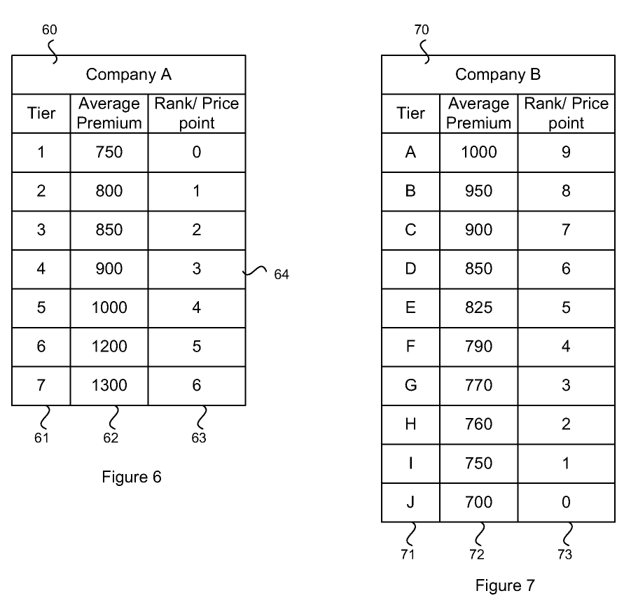

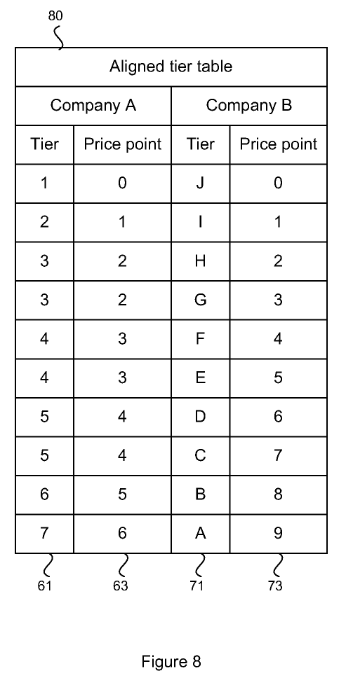

An example showing tier alignment will now be described. A tier table 60 for Company A is shown in FIG. 6. The tier table 60 is similar to the credit score tables of the credit score example described above and correlates the tier levels 61 of Company A with the average insurance premium 62 for that tier level. In the tier table 60, seven distinct tier levels 61 are shown and each tier level is given a price point ranking 63. A tier table 70 for Company B, showing ten distinct tier levels 71 is illustrated in FIG. 7. The tier table 70 provides a ranking 73 of the tiers 71 by their associated price point 72. Using the same price point alignment method described above, tier alignment may be performed to generate an aligned tier table 80 as shown in FIG. 8 which aligns the price points 63, 73 to produce an alignment of the tiers 61, 71.

The number of entries in the aligned tier table 80 will be equivalent to the number of entries of the largest tier table. In the present example, tier table 70 has 10 tiers and so the aligned table 80 will consist of 10 entries. Unlike the credit scores example discussed above which had an integer mapping between the two tier tables (i.e. a 2 to 1 mapping from Table 30 to Table 40), in this example, there is no integer mapping between the tier tables 60, 70. In order to provide the alignment, additional entries must be generated for Table 60 to produce an accurate alignment In one embodiment, additional entries may be generated commencing from the mean price point 64 of Table 60. Alternative methods for generating and distributing the additional entries required for the alignment tables will be apparent to a person skilled in the art and all such methods are considered to be equivalent.

The quotes used to form the dataset may be derived in a number of ways. In one embodiment, quotes are made to be market specific, with independent markets for vehicle finance insurance, mortgage insurance, and many other insurance types. The price points will depend on the quotes in the respective datasets, since these quotes are used to determine the average premiums. In one embodiment for vehicle finance insurance, the dataset quotes may initially be derived from a one driver, one vehicle quote. The quote characteristics or variables may then be modified through a range of combinations that, in combination with the credit score, affect the final premium, to obtain a dataset from which average premiums may be calculated. Such variables may be determined from rate guides and filings and may include such variables as prior liability limits, number of claims, lapse-in-insurance and operator age. A person skilled in the art will recognize other insurance markets and other types of variables for which quote data can be obtained and aligned.

While the examples above discuss a two company example, the alignment procedure may be readily extended to any number of companies by repeating the procedure of ranking individual companies according to price points, and then aligning the price points for all companies to be included in the analysis.

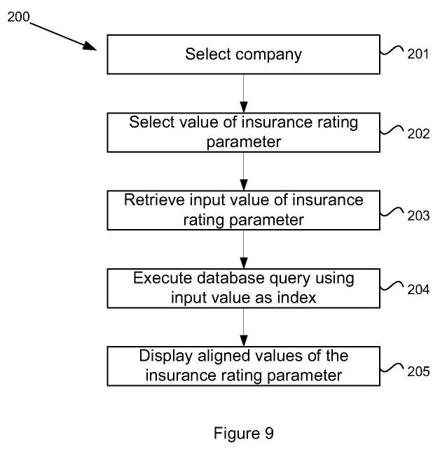

An aligned table of insurance rating parameter values such as table 50 or table 80 may be used in a manner of ways. In one embodiment, a user may use an aligned data table as a look-up to input a credit score or tier of a first company and obtain price point equivalent credit scores or tiers of other companies. A process for providing look-up is illustrated in the flowchart 200 of FIG. 9. At step 201, a user at an interface such as the host interface 12, selects a company and then selects a value of an insurance rating parameter such as a credit score or tier 202, e.g. from a list box of available entries, to be used as an index to the aligned data table. At step 203, the host interface retrieves the input value from the interface and then executes a database query 204 using the input value as an index to retrieve aligned insurance rating parameter values from other companies in the aligned data table. In this process, the aligned data table may be previously stored in the database 14 or may be generated immediately prior to look-up. The aligned credit scores are then presented to the user 205 in a suitable display, such as on a display of the host interface 12.

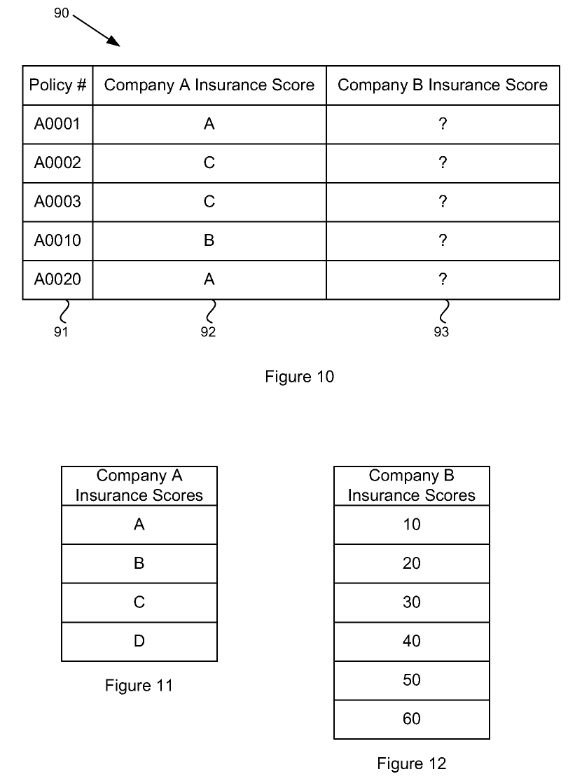

This alignment method allows the user to determine a one-to-one correlation for a company's insurance score to another company's insurance score. Being able to do this will result in a better “apples to apples” comparison between two or more insurance company's premiums for a given policy. In one example, a rate analyst for an insurance company would like to determine how competitive the auto rates are for the company he works for (Company A) compared against a competitor (Company B) for a certain group of policies. For this example, the analyst's company's book of business 90 is shown in FIG. 10, which relates a policy number 91 with an insurance score 92. To do this, the analyst would have to determine the premiums for Company A and Company B for each policy in that book. Determining a more accurate premiums correlation for Company A and Company B would require knowing what insurance score is assigned to each policy for each of the companies. Since the analyst is using his company's book of business, as shown in FIG. 10, the policies would already contain company A's insurance score 92. What is unknown, is how the insurance score's for Company B 93 align with the insurance scores for Company A

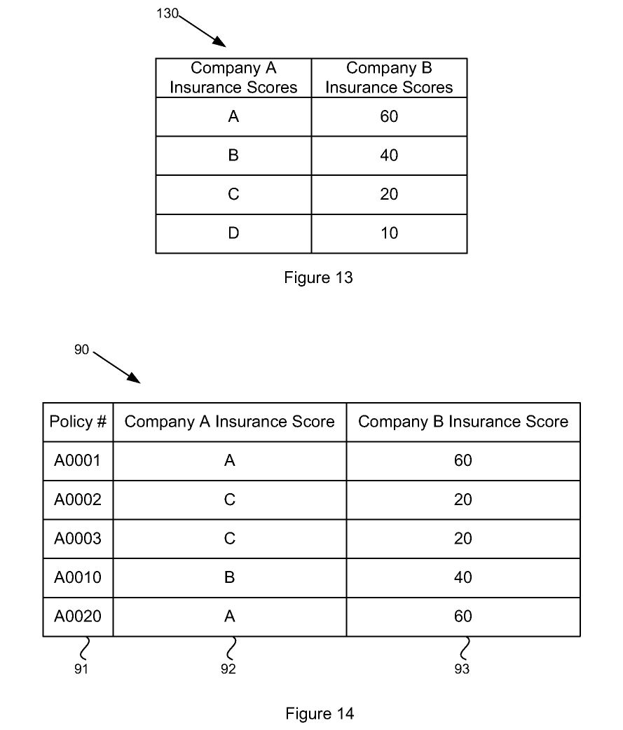

In the present example, company A may have scores as shown in FIG. 11 and company B may have scores as shown in FIG. 12. By implementing the credit alignment method described above, the analyst can build a table 130 mapping each available insurance score in company A to an insurance score for company B, for example, as shown in FIG. 13. The alignment table 130 may be constructed at the time of the analysis or may have been previously constructed so that all the analyst has to do is reference the table 130 to complete the rating table 90 as shown in FIG. 11, to determine what insurance score to use for company B when rating each of the policies. At this point, the analyst can use the Company B score column 93 for each of the policies he wants to determine premiums for Company B.

In one embodiment, the host interface may allow a user to use a selected company's score saved in a quote when rating and aligning the scores of other companies with this score. This is useful when a list of quotes has been created with scores saved for a specific company. The user selects the company from the available companies and enters the score from a quote which is then used as an index to the database query, similar for the look-up scores embodiment described above.

In one embodiment, the host interface may allow a user to select only a particular market and then select an “All Scores” icon that retrieves all credit scores for the market and all credit scores of other markets that are aligned to the selected market's scores.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for aligning an insurance rating parameter for a plurality of insurance carriers, the method comprising:
(A) creating a first dataset of quotes from a first company, the first dataset associating a plurality of insurance premiums with a plurality of the insurance rating parameter of the first company;
(B) ranking the first dataset of quotes according to the insurance premiums;
(C) creating a second dataset of quotes from a second company, the second dataset associating a plurality of insurance premiums with a plurality of the insurance rating parameter of the second company;
(D) ranking the second dataset of quotes according to the insurance premiums; and
(E) aligning the ranking of the first dataset with the ranking of the second dataset such that an aligned dataset correlates the insurance rating parameter of the first company and the second company.

2. The method of claim 1 comprising displaying the correlation of the insurance rating parameter.

3. The method of claim 1 comprising storing the correlation of the insurance rating parameter in a database.

4. The method of claim 1 wherein creating a dataset of quotes comprises:
(A) determining a first value of the insurance rating parameter and at least one input variable;
(B) generating a first quote for the first value of the insurance rating parameter and at least one input variable;
(C) modifying the at least one input variable; and
(D) generating at least one further quote for the first value of the insurance rating parameter and the at least one modified input variable.

5. The method of claim 4 comprising generating a quote for each unique value of the insurance rating parameter.

6. The method of claim 4 comprising generating a quote for each value of the insurance rating parameter that generates a unique insurance premium value.

7. The method of claim 4 comprising generating a quote for a plurality of values of the at least one input value, wherein ranking a dataset according to insurance premiums comprises calculating an average insurance premium for a value of the insurance rating parameter.

8. The method of claim 7 comprising calculating an average insurance premium for each unique value of the insurance rating parameter in a dataset.

9. The method of claim 1 comprising, for each unique value of the insurance rating parameter in a dataset, averaging the insurance premiums associated with the respective value of the insurance rating parameter.

10. The method of claim 9 wherein ranking a dataset comprises ranking the dataset according to an average insurance premium for a value of the insurance rating parameter.

11. The method of claim 1 comprising mapping the ranking of the first dataset to the ranking of the second dataset.

12. The method of claim 1 wherein the insurance rating parameter comprises a credit score.

13. The method of claim 1 wherein the insurance rating parameter comprises a tier.

14. A method for correlating a first company's credit score with at least one other company's credit score, the method comprising:
(A) receiving an input credit score for the first company;
(B) using the input credit score as an index to a database that stores correlated credit scores for a plurality of companies; and
(C) retrieving from the database a correlated credit score of at least one other company.

15. A method for correlating a first company's tiers with at least one other company's tiers, the method comprising:
(A) receiving an input tier for the first company;
(B) using the input tier as an index to a database that stores correlated tiers for a plurality of companies; and
(C) retrieving from the database a correlated tier of at least one other company.

16. A system comprising:
(A) a database that stores a plurality of datasets, each dataset associating a plurality of insurance premiums with a plurality of values of an insurance rating parameter; and
(B) a host configured to execute a query on the database to align the insurance rating parameter of a first company with the insurance rating parameter of at least one further company.

17. The system of claim 16 wherein the host is configured to interface with at least one insurance carrier to retrieve quote data from the at least one insurance carrier and to add the quote data to a dataset in the database that is associated with the insurance carrier.

18. The system of claim 16 wherein the host is configured to execute a query on the database that ranks the insurance rating parameter within each dataset by the average insurance premium for an associated value of the insurance rating parameter.

19. The system of claim 18 wherein the host is configured to execute a query on the database that aligns the rank of the insurance rating parameter of a first company with a rank of the insurance rating parameter of at least one further company.

20. The system of claim 19 wherein the host is configured to map the rank of an insurance rating parameter of the first company to the rank of an insurance rating parameter of at least one further company.

21. The system of claim 16 wherein the host is configured to:
(A) allow a user to indicate a plurality of companies and at least one value of the insurance rating parameter of at least one of the indicated companies; and
(B) execute a query on the database that returns a value of the insurance rating parameter of each of the indicated plurality of companies that are correlated with the at least one indicated value of the insurance rating parameter.

22. The system of claim 16 wherein the insurance rating parameter comprises a credit score.

23. The system of claim 16 wherein the insurance rating parameter comprises a tier.
